(19) United States
(12) Patent Application Publication
(10) Pub. No.: US 2021/0333238 A1
(43) Pub. Date: Oct. 28, 2021

(54) SCALE AND CORROSION MONITORING SYSTEM USING ULTRASONIC GUIDED WAVES

(71) Applicant: Saudi Arabian Oil Company, Dhahran (SA)

(72) Inventors: Abubaker Saeed, Dhahran (SA); Arno Willem Frederik Volker, Delft (NL); Paul Louis Maria Joseph van Neer, Bergschenhoek (NL); Daniele Piras, Amsterdam (NL); Arnout Tim van Zon, Woerden (NL)

(21) Appl. No.: 16/859,515

(22) Filed: Apr. 27, 2020

(51) Int. Cl. G01N 29/11; G01N 29/34; G01B 17/02

(52) U.S. Cl. CPC G01N 29/11; G01N 2291/02854; G01B 17/02; G01N 29/34

(57) ABSTRACT

A nondestructive method of monitoring scale buildup in a section of pipe includes: transmitting, from a first transducer at a first location of the pipe, axisymmetric torsional ultrasonic guided waves (UGWs) to propagate along the pipe, the torsional UGWs spanning a frequency band comprising multiple higher order modes; receiving, by a second transducer at a second location of the pipe, the propagated torsional UGWs; and determining a thickness of the scale buildup in the pipe between the first location and the second locations using the received torsional UGWs. The determining step comprises: measuring attributes from the received torsional UGWs, the attributes being first arrival times or mode cutoff frequencies; comparing the measured attributes to sets of computed said attributes, each set representing a different scale buildup thickness; and selecting the compared set of computed attributes that is closest to the measured attributes.

### FIELD OF THE DISCLOSURE

The present disclosure relates generally to nondestructive testing (NDT), and specifically to a scale and corrosion monitoring system using ultrasonic guided waves (UGWs), such as for monitoring scale buildup and corrosion damage in oil and gas tubing, pipes, and pipelines.

### BACKGROUND OF THE DISCLOSURE

On the inner surface of fluid (gas and liquid) transport pipes and tubing a layer of material, such as scale or fouling, can deposit. This buildup constricts the pipe, leading to undesired effects such as increased pressure or decreased flow within the pipe. Scale buildup in gas and oil wells and in flowlines is a major problem in insuring adequate flow in the wells and flowlines. For example, Scale buildup reduces wellbore accessibility, inhibits production engineers from achieving downhole control, reduces the gas or oil production rate, and, in some cases, forces well shutdowns. In addition, the pipe or tubing walls are often metal, which can be subject to corrosion over time. This leads to undesired effects such as pipe failure or costly replacement/repair of the corroded sections of the pipe. For example, corrosion in downhole production tubing can lead to unintended communication between the downhole tubing and the tubing casing annulus (TCA).

It is in regard to these and other problems in the art that the present disclosure is directed to provide a technical solution for an effective scale and corrosion monitoring system using UGWs.

### SUMMARY OF THE DISCLOSURE

According to an embodiment, a nondestructive method of monitoring scale buildup in at least one section of pipe is provided. The method comprises: transmitting, from a first transducer at a first location of the pipe, axisymmetric torsional ultrasonic guided waves (UGWs) to propagate along the pipe, the torsional UGWs spanning a frequency band comprising multiple higher order modes; receiving, by a second transducer at a second location of the pipe separated from the first location, the propagated torsional UGWs; and determining, by a processing circuit, a thickness of the scale buildup in the pipe between the first location and the second location using the received torsional UGWs. The determining comprises: measuring attributes from the received torsional UGWs, the attributes being first arrival times or mode cutoff frequencies; comparing the measured attributes to sets of computed said attributes, each set representing a different scale buildup thickness; selecting the compared set of computed attributes that is closest to the measured attributes; and outputting the scale buildup thickness corresponding to the selected set for the section of pipe between the first and second locations.

In an embodiment, the second transducer comprises a ring of second transducers about a circumference of the pipe at the second location, each second transducer corresponding to a different circumferential position about the pipe, and determining the thickness of the scale buildup comprises determining the thickness of the scale buildup for each circumferential position about the pipe using the received torsional UGWs of the corresponding second transducer.

In an embodiment, the method further comprises: transmitting, from a third transducer at a third location of the pipe, axisymmetric longitudinal UGWs to propagate along the pipe, the longitudinal UGWs spanning a frequency band comprising multiple higher order modes; receiving, by a fourth transducer at a fourth location of the pipe separated from the third location, the propagated longitudinal UGWs; and determining, by the processing circuit, the thickness of the scale buildup in the pipe between the third location and the fourth location using the received longitudinal UGWs. This determining comprises: measuring the attributes from the received longitudinal UGWs; comparing the measured longitudinal attributes to second sets of computed said attributes, each second set representing a different scale buildup thickness; selecting the compared second set of computed attributes that is closest to the measured longitudinal attributes; and outputting the scale buildup thickness corresponding to the selected second set for a second section of pipe between the third and fourth locations.

In an embodiment, the distance between the first and third locations of the pipe is the same as the distance between the second and fourth locations of the pipe.

In an embodiment, a nondestructive method of monitoring scale buildup and corrosion in a pipe uses the above method and further comprises: transmitting, from a third transducer at a third location of the pipe, axisymmetric longitudinal UGWs to propagate along the pipe, the longitudinal UGWs spanning a frequency band comprising multiple higher order modes; receiving, by a fourth transducer at a fourth location of the pipe separated from the third location, the propagated longitudinal UGWs; and determining, by the processing circuit, the thickness of the wall of the pipe between the third location and the fourth location using the received longitudinal UGWs. This determining comprises: measuring the attributes from the received longitudinal UGWs; comparing the measured longitudinal attributes to second sets of computed said attributes, each second set representing a different pipe wall thickness; selecting the compared second set of computed attributes that is closest to the measured longitudinal attributes; and outputting the pipe wall thickness corresponding to the selected second set for the second section of pipe between the third and fourth locations.

In an embodiment: the second transducer comprises a ring of second transducers about a circumference of the pipe at the second location, each second transducer corresponding to a different circumferential position about the pipe, and determining the thickness of the scale buildup comprises determining the thickness of the scale buildup for each circumferential position about the pipe using the received torsional UGWs of the corresponding second transducer; and the fourth transducer comprises a ring of fourth transducers about a circumference of the pipe at the fourth location, each fourth transducer corresponding to a different circumferential position about the pipe, and determining the thickness of the pipe wall comprises determining the thickness of the pipe wall for each circumferential position about the pipe using the received longitudinal UGWs of the corresponding fourth transducer.

In an embodiment, the second location of the pipe coincides with the fourth location, and the second transducers interleave with the fourth transducers about the circumference of the pipe.

According to another embodiment, a nondestructive method of monitoring scale buildup and corrosion in a pipe is provided. The method comprises: transmitting, from a first transducer at a first location of the pipe, axisymmetric torsional ultrasonic guided waves (UGWs) to propagate along the pipe, the torsional UGWs spanning a frequency band comprising multiple higher order modes; receiving, by a second transducer at a second location of the pipe separated from the first location, the propagated torsional UGWs; transmitting, from a third transducer at a third location of the pipe, axisymmetric longitudinal UGWs to propagate along the pipe, the longitudinal UGWs spanning a frequency band comprising multiple higher order modes; receiving, by a fourth transducer at a fourth location of the pipe separated from the third location, the propagated longitudinal UGWs; and determining, by a processing circuit, a thickness of the scale buildup in the pipe and a thickness of the wall of the pipe using the received torsional UGWs and the received longitudinal UGWs. The determining comprises: measuring attributes from the received torsional UGWs and the received longitudinal UGWs, the attributes being first arrival times or mode cutoff frequencies; comparing the measured attributes to sets of computed said attributes, each set representing a different combination of scale buildup thickness and pipe wall thickness; selecting the compared set of computed attributes that is closest to the measured attributes; and outputting the scale buildup thickness and the pipe wall thickness corresponding to the selected set for a second section of pipe between the third and fourth locations.

In an embodiment: the second transducer comprises a ring of second transducers about a circumference of the pipe at the second location, each second transducer corresponding to a different circumferential position about the pipe; the fourth transducer comprises a ring of fourth transducers about a circumference of the pipe at the fourth location, each fourth transducer corresponding to a different circumferential position about the pipe; and determining the thickness of the scale buildup and the thickness of the pipe wall comprises determining the thickness of the scale buildup and the thickness of the pipe wall for each circumferential position about the pipe using the received torsional UGWs of the corresponding second transducer and the received longitudinal UGWs of the corresponding fourth transducer.

In an embodiment, the second location of the pipe coincides with the fourth location, and the second transducers interleave with the fourth transducers about the circumference of the pipe.

According to yet another embodiment, a system for nondestructively monitoring scale buildup in a section of pipe is provided. The system comprises: a first transducer configured to transmit axisymmetric torsional ultrasonic guided waves (UGWs) from a first location of the pipe, to propagate along the pipe, the torsional UGWs spanning a frequency band comprising multiple higher order modes; a second transducer configured to receive the propagated torsional UGWs at a second location of the pipe separated from the first location; and a processing circuit configured to determine a thickness of the scale buildup in the pipe between the first location and the second location using the received torsional UGWs by: measuring attributes from the received torsional UGWs, the attributes being first arrival times or mode cutoff frequencies; comparing the measured attributes to sets of computed said attributes, each set representing a different scale buildup thickness; selecting the compared set of computed attributes that is closest to the measured attributes; and outputting the scale buildup thickness corresponding to the selected set for the section of pipe between the first and second locations.

In an embodiment, the second transducer comprises a ring of second transducers about a circumference of the pipe at the second location, each second transducer corresponding to a different circumferential position about the pipe, and the processing circuit determines the thickness of the scale buildup by determining the thickness of the scale buildup for each circumferential position about the pipe using the received torsional UGWs of the corresponding second transducer.

In an embodiment, the system further comprises: a third transducer configured to transmit axisymmetric longitudinal UGWs from a third location of the pipe, to propagate along the pipe, the longitudinal UGWs spanning a frequency band comprising multiple higher order modes; and a fourth transducer configured to receive the propagated longitudinal UGWs at a fourth location of the pipe separated from the third location. The processing circuit is further configured to determine the thickness of the scale buildup in the pipe between the third location and the fourth location using the received longitudinal UGWs by: measuring the attributes from the received longitudinal UGWs; comparing the measured longitudinal attributes to second sets of computed said attributes, each second set representing a different scale buildup thickness; selecting the compared second set of computed attributes that is closest to the measured longitudinal attributes; and outputting the scale buildup thickness corresponding to the selected second set for a second section of pipe between the third and fourth locations.

In an embodiment, the distance between the first and third locations of the pipe is the same as the distance between the second and fourth locations of the pipe.

In an embodiment, a nondestructive system of monitoring scale buildup and corrosion in a pipe uses the above system and further comprises: a third transducer configured to transmit axisymmetric longitudinal UGWs, from a third location of the pipe, to propagate along the pipe, the longitudinal UGWs spanning a frequency band comprising multiple higher order modes; and a fourth transducer configured receive the propagated longitudinal UGWs at a fourth location of the pipe separated from the third location. The processing circuit is further configured to determine the thickness of the wall of the pipe between the third location and the fourth location using the received longitudinal UGWs by: measuring the attributes from the received longitudinal UGWs; comparing the measured longitudinal attributes to second sets of computed said attributes, each second set representing a different pipe wall thickness; selecting the compared second set of computed attributes that is closest to the measured longitudinal attributes; and outputting the pipe wall thickness corresponding to the selected second set for the second section of pipe between the third and fourth locations.

In an embodiment: the second transducer comprises a ring of second transducers about a circumference of the pipe at the second location, each second transducer corresponding to a different circumferential position about the pipe, and the processing circuit determines the thickness of the scale buildup by determining the thickness of the scale buildup for each circumferential position about the pipe using the received torsional UGWs of the corresponding second transducer; and the fourth transducer comprises a ring of fourth transducers about a circumference of the pipe at the fourth location, each fourth transducer corresponding to a different circumferential position about the pipe, and the processing circuit determines the thickness of the pipe wall by determining the thickness of the pipe wall for each circumferential position about the pipe using the received longitudinal UGWs of the corresponding fourth transducer.

In an embodiment, the second location of the pipe coincides with the fourth location, and the second transducers interleave with the fourth transducers about the circumference of the pipe.

In still yet another embodiment, a system for nondestructively monitoring scale buildup and corrosion in a pipe is provided. The system comprises: a first transducer configured to transmit axisymmetric torsional ultrasonic guided waves (UGWs) from a first location of the pipe, to propagate along the pipe, the torsional UGWs spanning a frequency band comprising multiple higher order modes; a second transducer configured to receive the propagated torsional UGWs at a second location of the pipe separated from the first location; a third transducer configured to transmit axisymmetric longitudinal UGWs from a third location of the pipe, to propagate along the pipe, the longitudinal UGWs spanning a frequency band comprising multiple higher order modes; a fourth transducer configured to receive the propagated longitudinal UGWs at a fourth location of the pipe separated from the third location; and a processing circuit configured to determine a thickness of the scale buildup in the pipe and a thickness of the wall of the pipe using the received torsional UGWs and the received longitudinal UGWs by: measuring attributes from the received torsional UGWs and the received longitudinal UGWs, the attributes being first arrival times or mode cutoff frequencies; comparing the measured attributes to sets of computed said attributes, each set representing a different combination of scale buildup thickness and pipe wall thickness; selecting the compared set of computed attributes that is closest to the measured attributes; and outputting the scale buildup thickness and the pipe wall thickness corresponding to the selected set for a second section of pipe between the third and fourth locations.

In an embodiment: the second transducer comprises a ring of second transducers about a circumference of the pipe at the second location, each second transducer corresponding to a different circumferential position about the pipe; the fourth transducer comprises a ring of fourth transducers about a circumference of the pipe at the fourth location, each fourth transducer corresponding to a different circumferential position about the pipe; and the processing circuit determines the thickness of the scale buildup and the thickness of the pipe wall by determining the thickness of the scale buildup and the thickness of the pipe wall for each circumferential position about the pipe using the received torsional UGWs of the corresponding second transducer and the received longitudinal UGWs of the corresponding fourth transducer.

In an embodiment, the second location of the pipe coincides with the fourth location, and the second transducers interleave with the fourth transducers about the circumference of the pipe.

Any combinations of the various embodiments and implementations disclosed herein can be used. These and other aspects and features can be appreciated from the following description of certain embodiments together with the accompanying drawings and claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a dispersion diagram illustrating several phase velocity dispersion curves for corresponding orders of S-mode, A-mode, and SH-mode ultrasonic guided waves (UGWs) in an example pipe, such as a pipe being monitored by a scale and corrosion monitoring system, according to an embodiment.

FIG. 2 is an illustration of an analytical expression for deriving a two-layer reflection coefficient for example mathematical modeling of propagating UGWs in a two-layer system (e.g., scale buildup and corrosion) of a pipe, such as for use with a scale and corrosion monitoring system, according to an embodiment.

FIG. 3 is a schematic diagram of an example sensor layout including a pair of transducer ring arrays circumferentially deployed about a pipe, the ring arrays for transmitting and receiving torsional and longitudinal UGWs as part of a scale and corrosion monitoring system, according to an embodiment.

FIG. 4 is a graphical plot of an example received and recorded longitudinal UGW signal, such as for use as part of a scale and corrosion monitoring system, according to an embodiment.

FIG. 5 is a color plot of time-frequency analysis for torsional UGWs, illustrating the first arrival times as a function of frequency and the horizontal lines at later times representing the mode cutoff frequencies, such as for use as part of a scale and corrosion monitoring system, according to an embodiment.

FIG. 6 is a corresponding color plot of time-frequency analysis to the plot of FIG. 5, only this time for longitudinal UGWs, again illustrating the first arrival times as a function of frequency and the horizontal lines at later times representing the mode cutoff frequencies.

FIG. 7 is a color plot illustrating an example scale thickness determination based on first arrival time measurements using a time-frequency analysis, with overlaying computed group velocity dispersion curves, such as for use with a scale and corrosion monitoring system, according to an embodiment.

FIG. 8A is a corresponding graph of the first arrival time measurements of FIG. 7 overlaying a corresponding graph of the minimum computed group velocity dispersion curve of FIG. 7.

FIG. 8B is a corresponding graph of an example objective function that measures how well the first arrival time measurements of FIGS. 7 and 8A fit the respective minimum computed group velocity dispersion curves for different scale thicknesses, together with an identification of the determined minimum objective function (best fit) and corresponding scale thickness, such as for use with a scale and corrosion monitoring system, according to an embodiment.

FIG. 9 is a corresponding bar graph of the scale thicknesses (or scale thickness profile) at 16 different angular positions around the pipe circumference, as determined using the technique illustrated in FIGS. 7-8B on respective sets of first arrival time measurements from respective circumferentially positioned transducers.

FIG. 10 is a color plot illustrating example scale thickness and pipe wall thickness (corrosion) determinations based on first arrival time measurements using torsional UGWs and a (two-dimensional) time-frequency analysis, with overlaying minimum computed group velocity dispersion curve, such as for use with a scale and corrosion monitoring system, according to an embodiment.

FIG. 11 is a corresponding color plot of two-dimensional time-frequency analysis and overlaying minimum computed group velocity dispersion curve to the plot of FIG. 10, only this time for longitudinal UGWs.

FIG. 12A is a corresponding graph of the first arrival time measurements and minimum computed group velocity dispersion curves of FIGS. 10 and 11.

FIG. 12B is a color plot of an example two-variable (wall thickness and scale thickness) objective function that measures how well the first arrival time measurements of FIGS. 10 and 11 fit the respective minimum computed group velocity dispersion curves, together with an identification of the determined minimum objective function (best fit), such as for use with a scale and corrosion monitoring system, according to an embodiment.

FIG. 13 is a corresponding schematic graph of the scale thicknesses (inside numbers) and wall thicknesses (corrosion indicator, outside numbers) at 16 different angular positions around the pipe circumference, as determined using the technique illustrated in FIGS. 10-12B on respective sets of first arrival time measurements from respective circumferentially positioned transducers.

FIG. 14 is a schematic diagram of an example scale and corrosion monitoring system using UGWs, according to an embodiment.

FIG. 15 is a flow diagram of an example method of scale and corrosion monitoring using UGWs, according to an embodiment.

It is noted that the drawings are illustrative and not necessarily to scale, and that the same or similar features have the same or similar reference numerals throughout.

### DETAILED DESCRIPTION OF CERTAIN EMBODIMENTS OF THE DISCLOSURE

In various example embodiments, a nondestructive scale and corrosion monitoring system using ultrasonic guided waves (UGWs) is provided. In some such embodiments, the system is used to monitor scale buildup and corrosion damage in oil and gas tubing, pipes, and pipelines (“pipes”). Scaling, fouling, or other depositing (“scale” or “scale buildup”) lines the interior of pipes and constricts their ability to transport fluids. Pipe wall thickness can be compromised by effects such as corrosion, erosion, and the like (“corrosion” or “wall thickness”). In example embodiments, a scale and corrosion monitoring system uses UGWs to nondestructively measure a pipe's scale buildup and corrosion. A pipe's geometry, use, and environment control such things as the pipe's scale and corrosion. When the pipe is used as a waveguide for UGWs (such as torsional and longitudinal UGWs), the degree of scale and corrosion impart distinct and measurable effects on the UGWs. Mathematical modeling can be used to map the different combinations of scale thickness and wall thickness to their corresponding impacts on the UGWs. Using these modeling results, in various embodiments, UGWs are measured, and their measurements fit to the closest modeled combination of scale and wall thicknesses to nondestructively determine the amount of scale buildup and corrosion in the pipe.

As discussed earlier, there are a number of problems associated with the effects of scaling and corrosion on pipes. For example, scale buildup in gas and oil wells and in flowlines is a major problem for insuring adequate flow of oil and gas. The problem is difficult to predict, which can make it difficult to mitigate. For instance, in a production tubing environment for an oil or gas well, vital information about the integrity and downhole flow conditions of the production well is normally difficult to obtain. One approach is to lower logging instruments equipped with sensors into the production tubing. However, these are complex and risky activities for which operation shutdowns are required, resulting in down time. The effects of corrosion and scale buildup are widespread and impact many existing wells and other pipes. Tubing casing annulus (TCA) communication is a direct result of downhole corrosion. In addition, scale buildup reduces wellbore accessibility, inhibits, production engineers from achieving downhole control, reduces the produced gas rate, and, in some cases, forces well shutdowns.

Accordingly, in example embodiments, a scale and corrosion monitoring system using UGWs is provided. In some embodiments, a method for scale detection and sizing based on UGWs is provided. In one such embodiment, two transducer rings are applied around the circumference of a pipe at longitudinally separated locations. Then longitudinal and torsional, axisymmetric UGWs are emitted from one of the transducer rings and propagate along the pipe, using the pipe as a waveguide. The other transducer ring receives and measures the propagated UGWs. A wide frequency band is used to ensure a sufficient number (such as three or more) of the higher order modes (in addition to the fundamental mode) are present in the received UGWs. These higher order modes propagate from a certain minimum (or fundamental) frequency. This minimum frequency is called the cutoff frequency of the wave mode and is physically associated to a standing elastic wave in the cross-section of the pipe wall and the scale buildup. There is often a direct relationship between the scale/wall thickness and the cutoff frequency. As such, in some embodiments, this relationship is used for sizing the scale thickness.

In some embodiments, a complex waveform is converted to a domain, where a simple feature (horizontal lines, as illustrated below) is extracted to provide a characteristic “spectral-lines” pattern. This characteristic line pattern can be explained in terms of a series of standing wave resonances, which can be computed from a simple one-dimensional (1D) model, while the wave propagation problem itself is a complex 3D wave propagation problem. In an example well embodiment, the first arriving wave modes do not couple to the liquid in the annulus and are less affected by rough scale than the wave modes near their cutoff frequency. In some embodiments, the first arrival time of torsional waves is particularly suitable for measuring scale thickness, while longitudinal waves provide good sensitivity for pipe wall thickness loss (e.g., corrosion).

In some embodiments, careful scale and corrosion monitoring allows mitigation measures to be applied when they are really needed, and to verify their efficiency. In some embodiments, the scale and corrosion monitoring system is permanently installed. The system provides frequent readings on scale buildup and corrosion. The system is designed such that it will not interfere/block, for example, the production tubing. In some embodiments, the techniques provide a direct physical relation between mode cutoff frequency and scale thickness. As such, these techniques are more suitable for scale thickness sizing. In some embodiments, scale and corrosion in pipes are measured or determined with great accuracy, allowing permanent continuous non-intrusive monitoring of a pipe.

In further detail, in some embodiments, scale monitoring of a pipe is performed using cutoff frequencies of higher order modes of UGWs transmitted along the pipe. In some embodiments, a scale and corrosion monitoring system uses torsional and/or longitudinal UGWs in a wide frequency range, such that several orders of higher order modes are present.

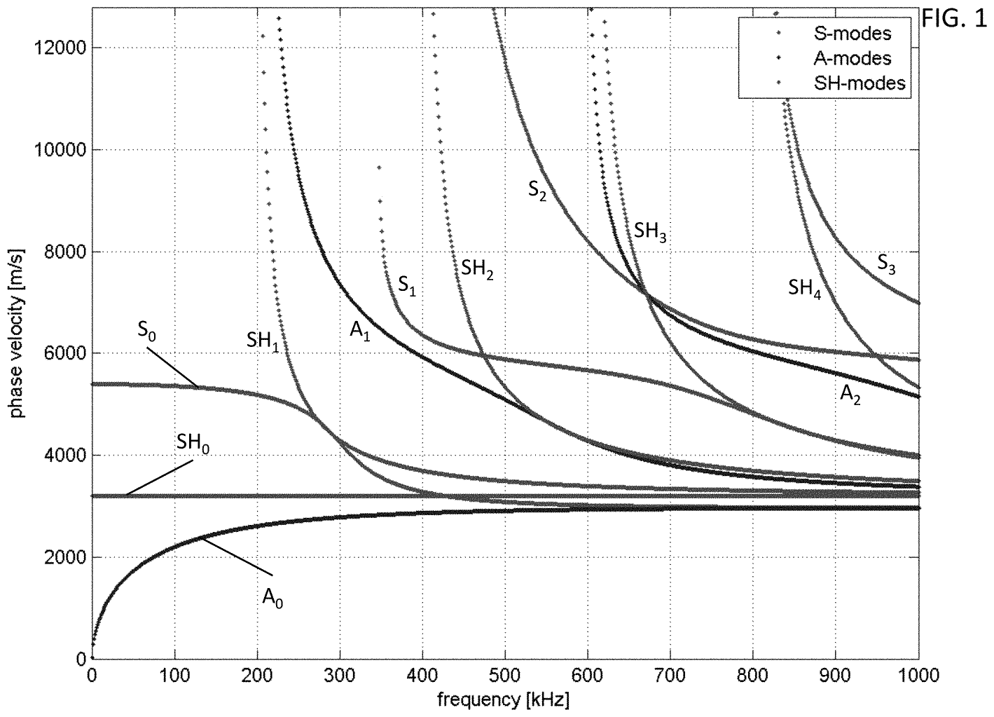

FIG. 1 is a dispersion diagram illustrating several phase velocity dispersion curves for corresponding orders of S-mode, A-mode, and SH-mode UGWs in an example pipe, such as a pipe being monitored by a scale and corrosion monitoring system, according to an embodiment. A dispersion curve is a plot of group or phase velocity (y-axis) as a function of frequency (x-axis). The curves are derived through modeling the transmission of UGWs in a pipe under certain assumed conditions (e.g., pipe thickness, scale thickness, reflection and transmission coefficients, propagation operators, and the like). Dispersion curves for the fundamental (S₀, A₀, and SH₀) frequencies as well as the first few higher order modes (e.g., S₁, A₁, SH₁, S₂, A₂, SH₂) are displayed in FIG. 1.

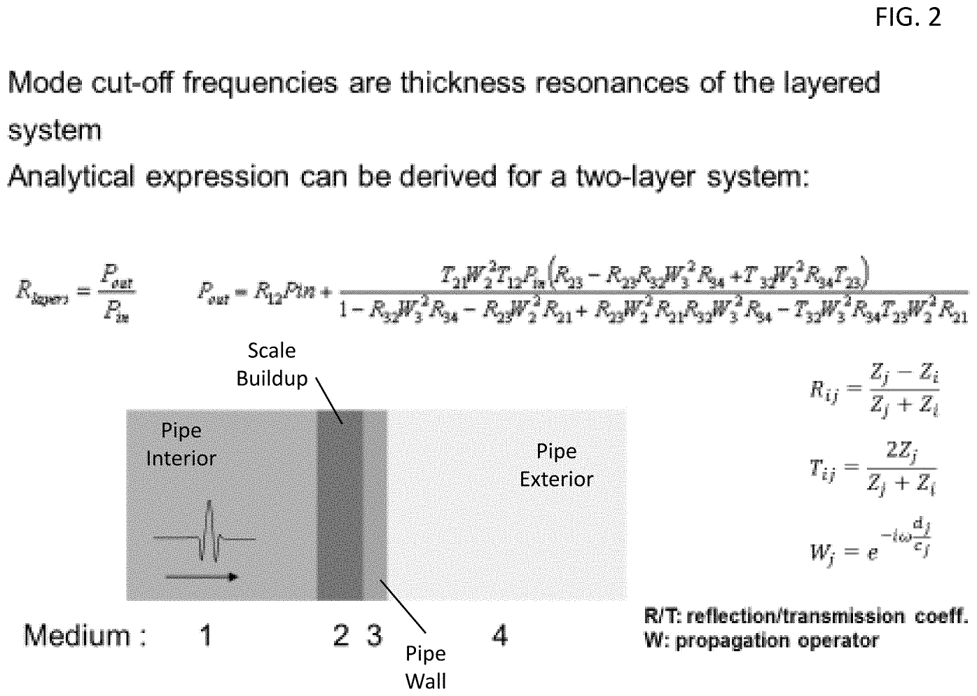

The cutoff frequency of these higher order modes are related to the standing wave resonance of, for example, the steel pipe wall and the attached scale (or fouling). While in general, the wave propagation problem is complex, in some embodiments, the mode cutoff frequencies are computed using a more straightforward two-layer reflection model. In addition, an analytical expression of the frequency dependent reflection coefficient is derived. The dips in the reflection coefficient are the mode cutoff frequencies. An example expression for determining the reflection coefficient is provided in FIG. 2.

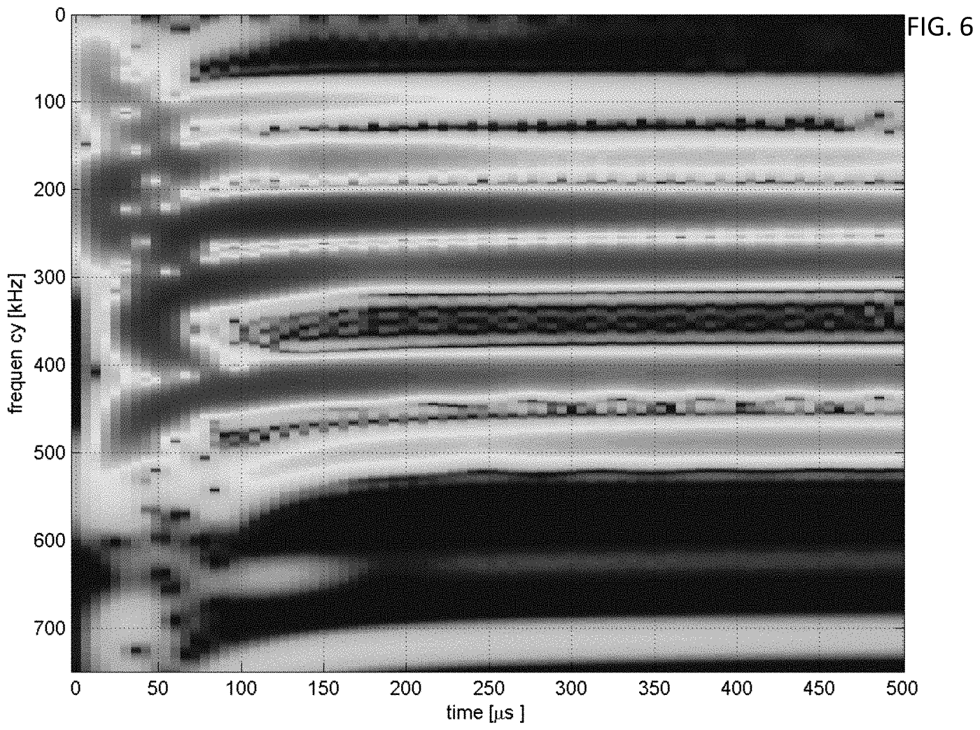

FIG. 2 is an illustration of an analytical expression for deriving a two-layer reflection coefficient for example mathematical modeling of propagating UGWs in a two-layer system (e.g., scale buildup and corrosion) of a pipe, such as for use with a scale and corrosion monitoring system, according to an embodiment. In the example analytical expression of FIG. 6, four different mediums are modeled: (1) the pipe's interior (e.g., waveguide for the UGWs, including fluids such as oil or gas normally present), (2) the scale buildup, (3) the pipe wall, and (4), the pipe's exterior (e.g., TCA fluid).

In some embodiments, the full dispersion relations for a layered system are solved. This provides information about the frequency-dependent amplitude and phase velocity of all wave modes, allowing for additional information on the scaling thickness. In some such embodiments, this is combined with an analysis of the multiples of each mode in a frequency band (e.g., the low frequencies, such that the T₀, A₀, and S₀ can be separated in time). The thickness of the scaling is then determined by analyzing the destructive interference of the first multiple and the first arrival. This interference causes notches in the frequency spectrum. In one such embodiment, when the wave velocity in the fouling layer or its thickness is low, the analysis is performed in the time domain.

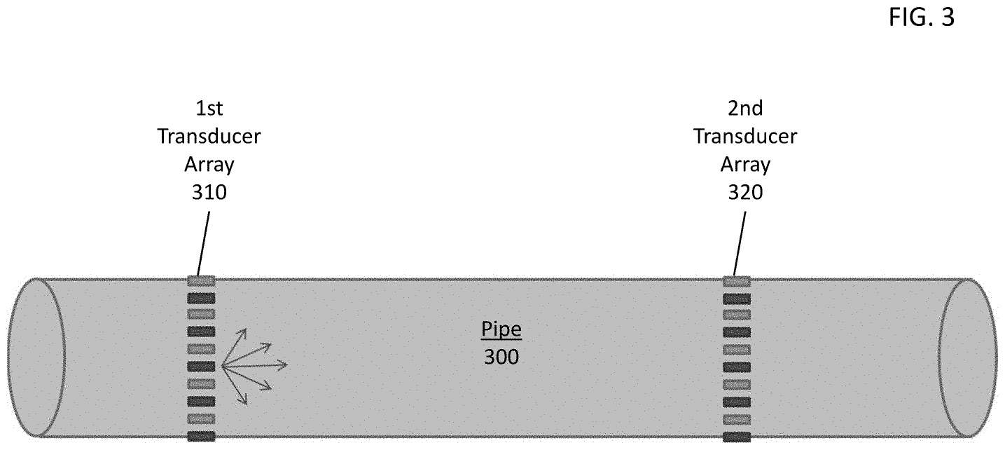

In some embodiments, to monitor the scale growth and/or wall loss due to corrosion, two circumferential arrays of ultrasound transducers are deployed around the pipe to generate the desired wave modes. In some such embodiments, the arrays include single type sensors (e.g., torsional or longitudinal). In some other such embodiments, the arrays are interleaved arrays (e.g., torsional alternating with longitudinal) as depicted in FIG. 3. The type of transducers is not particularly limited. For example, in some embodiments, piezo-electric transducers are used. In another embodiment, electro-magnetic acoustic transducers (EMATs) are used. In yet another embodiment, another type of transducer is used.

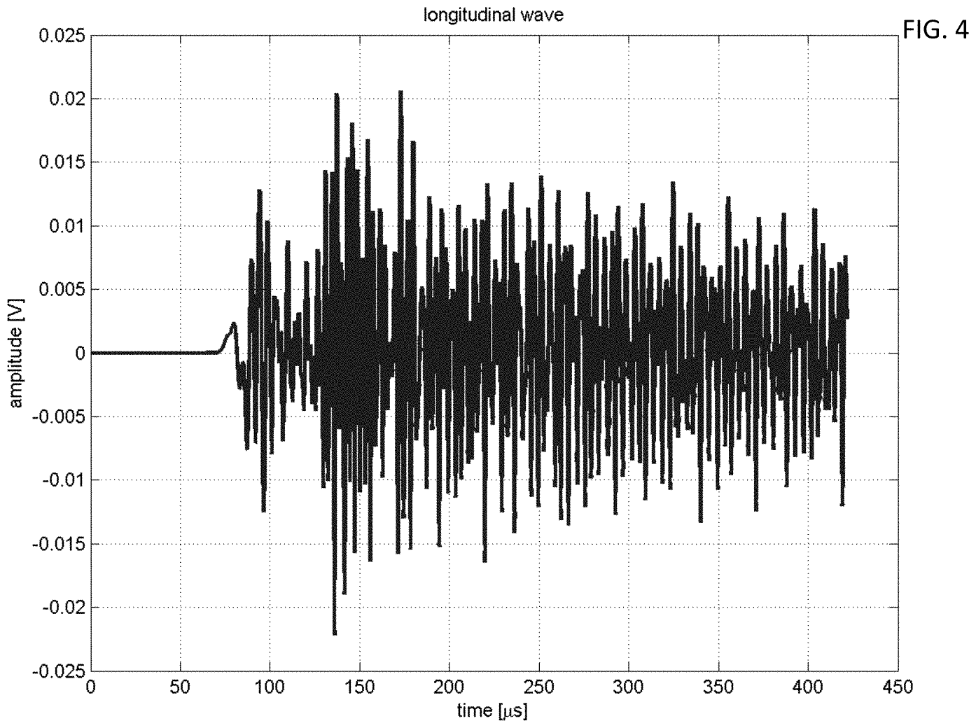

FIG. 3 is a schematic diagram of an example sensor layout including a pair of transducer ring arrays 310 and 320 circumferentially deployed about a pipe 300, the ring arrays 310 and 320 for transmitting and receiving torsional and longitudinal UGWs as part of a scale and corrosion monitoring system, according to an embodiment. The ring arrays include a first transducer array 310 and a second transducer array 320 longitudinally separated from the first transducer array 310. In some embodiments, the first transducer array 310 transmits the UGWs to propagate longitudinally along the interior of the pipe 300 while the second transducer array 320 receives the propagated UGWs. In some other embodiments, the roles of the first transducer array 310 and the second transducer array 320 are reversed. In some embodiments, the first and second transducer arrays 310 and 320 take turns transmitting the UGWs to each other. The sensors are mounted on the outside of the pipe (e.g., production tubing). An example recorded signal is shown in FIG. 4.

FIG. 4 is a graphical plot of an example received and recorded longitudinal UGW signal, such as for use as part of a scale and corrosion monitoring system, according to an embodiment. Here, the x-axis represents propagation time (in microseconds, or μs) while the y-axis represents UGW signal amplitude (in volts, or V).

In an example embodiment, the scale and monitoring system is deployed on a production tubing of a well. Here, only wave modes that have a shear motion relative to the liquid in the annulus (TCA) between the tubing and the casing are used. This helps ensure that the well completion will not affect the measurements of the scale thickness and corrosion.

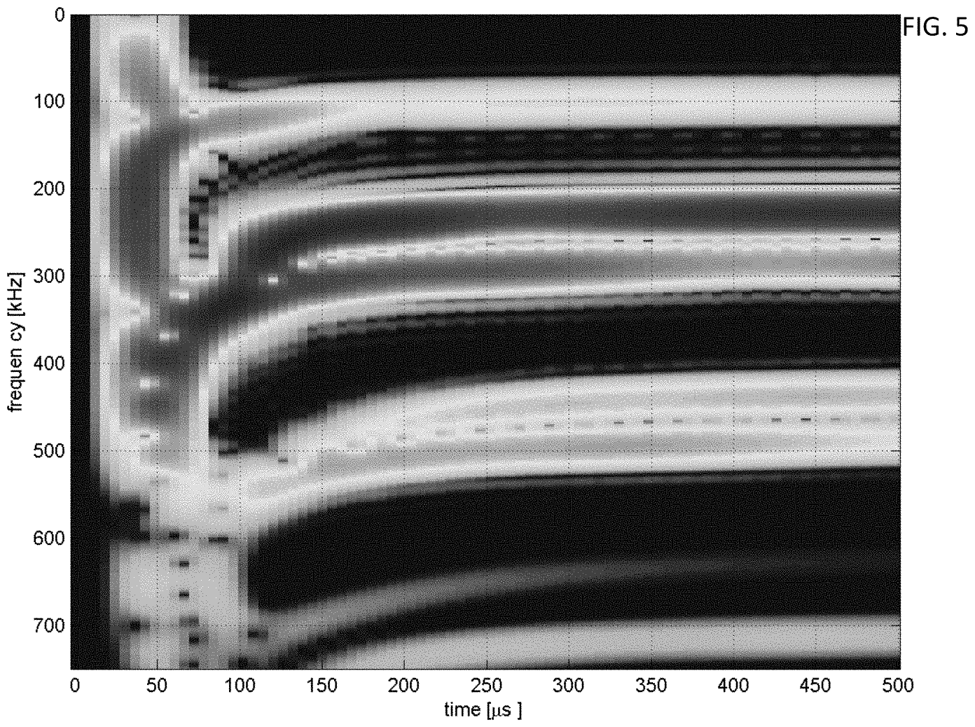

In an embodiment, the cutoff frequencies of the higher order modes are extracted from the data. This can, for example, be done by a time-frequency analysis. In other embodiments, alternative methods may be used. An example of a time frequency analysis is shown in FIGS. 5-6.

FIG. 5 is a color plot of time-frequency analysis for torsional UGWs, illustrating the first arrival times as a function of frequency and the horizontal lines at later times representing the mode cutoff frequencies, such as for use as part of a scale and corrosion monitoring system, according to an embodiment. FIG. 6 is a corresponding color plot of time-frequency analysis to the plot of FIG. 5, only this time for longitudinal UGWs, again illustrating the first arrival times as a function of frequency and the horizontal lines at later times representing the mode cutoff frequencies. In both FIGS. 5 and 6, the x-axis represents propagation time (in μs) while the y-axis represents UGW frequency (in kilohertz, or kHz).

With reference to FIGS. 5-6, the horizontal lines are the cutoff frequencies in this display of the data. In an embodiment, the cutoff frequencies are extracted from the data and used in an inversion scheme to estimate scale/wall thickness and scale material properties. In a similar fashion, these values are determined for different positions along the circumference of a pipe, such as through use of an equally-spaced array of transducers along the circumference of the pipe. In one such embodiment, the scale/wall thickness is determined and reported for 16 positions around the circumference.

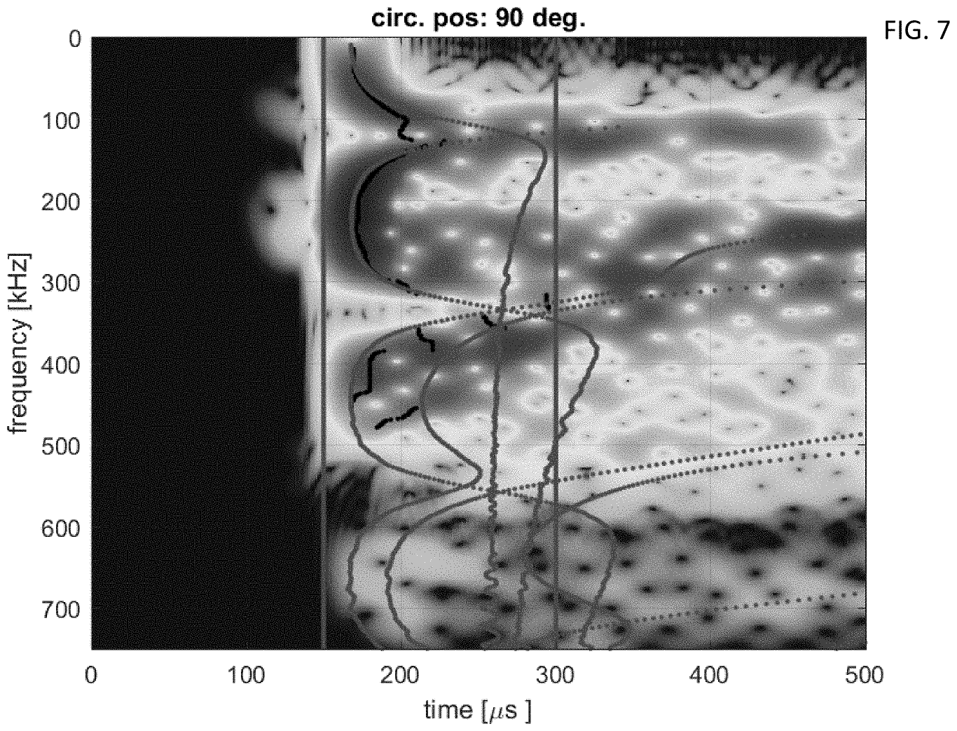

In some embodiments, the first arrival time of each frequency component in the spectrogram is used to determine the pipe wall thickness and the scale thickness. In some such embodiments, the first arrival time of both torsional and longitudinal modes together provide information on the scale thickness and the pipe wall thickness. Here, the first arrival times of both wave modes in the spectrogram in the frequency range from 100 kHz to 500 kHz are picked. The measured arrival times are compared to a model for a range of scale/tubing wall thicknesses. An example of this approach is illustrated in FIGS. 7-9.

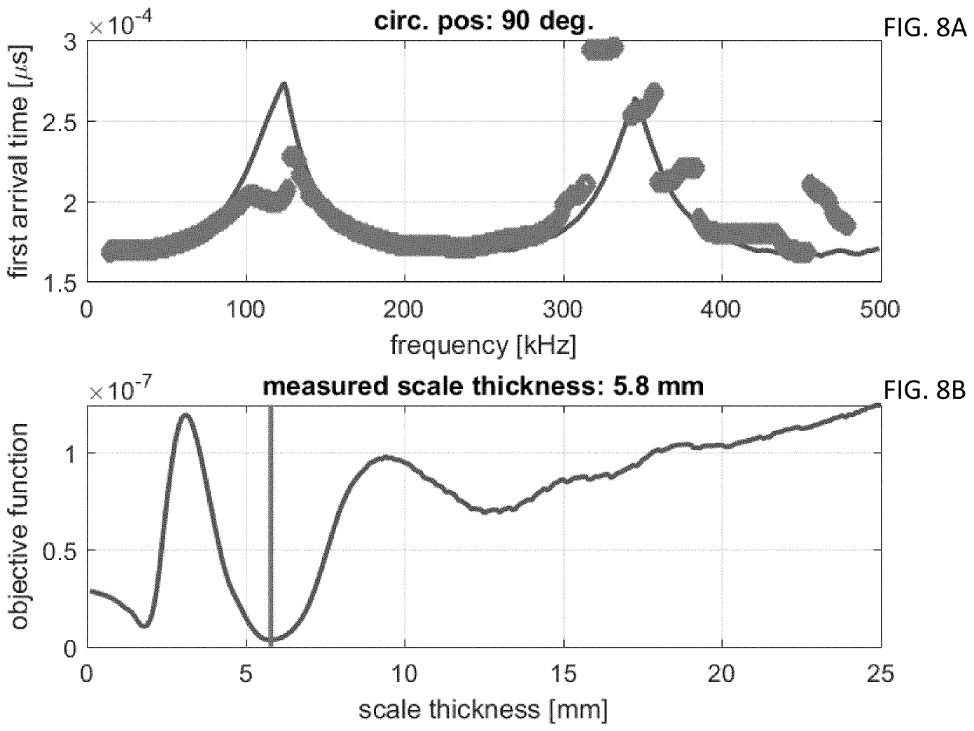

FIG. 7 is a color plot or spectrogram illustrating an example scale thickness determination based on first arrival time measurements using a time-frequency analysis, with overlaying computed group velocity dispersion curves, such as for use with a scale and corrosion monitoring system, according to an embodiment. In FIG. 7, the x-axis represents propagation time (in μs) while the y-axis represents UGW frequency (in kHz). FIG. 8A is a corresponding graph of the first arrival time measurements of FIG. 7 overlaying a corresponding graph of the minimum computed group velocity dispersion curve of FIG. 7. In FIG. 8A, the x-axis represents UGW frequency (in kHz) while the y-axis represents first arrival time (in hundreds of μs).

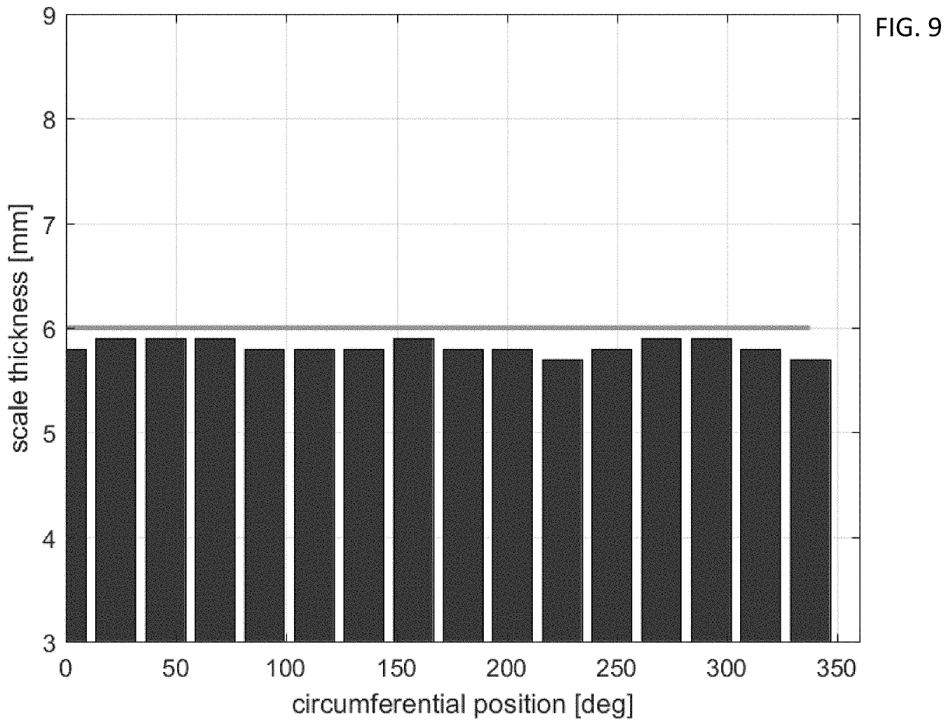

FIG. 8B is a corresponding graph of an example objective function that measures how well the first arrival time measurements of FIGS. 7 and 8A fit the respective minimum computed group velocity dispersion curves for different scale thicknesses, together with an identification of the determined minimum objective function (best fit) and corresponding scale thickness, such as for use with a scale and corrosion monitoring system, according to an embodiment. In FIG. 8B, the x-axis represents scale thickness (in millimeters, or mm) while the y-axis represents objective function value (with lower values representing a better fit of the modeled data to the measured data). FIG. 9 is a corresponding bar graph of the scale thicknesses (or scale thickness profile) at 16 different angular positions around the pipe circumference, as determined using the technique illustrated in FIGS. 7-8B on respective sets of first arrival time measurements from respective circumferentially positioned transducers. In FIG. 9, the x-axis represents circumferential position (in degrees) while the y-axis represents the determined scale thickness (in mm).

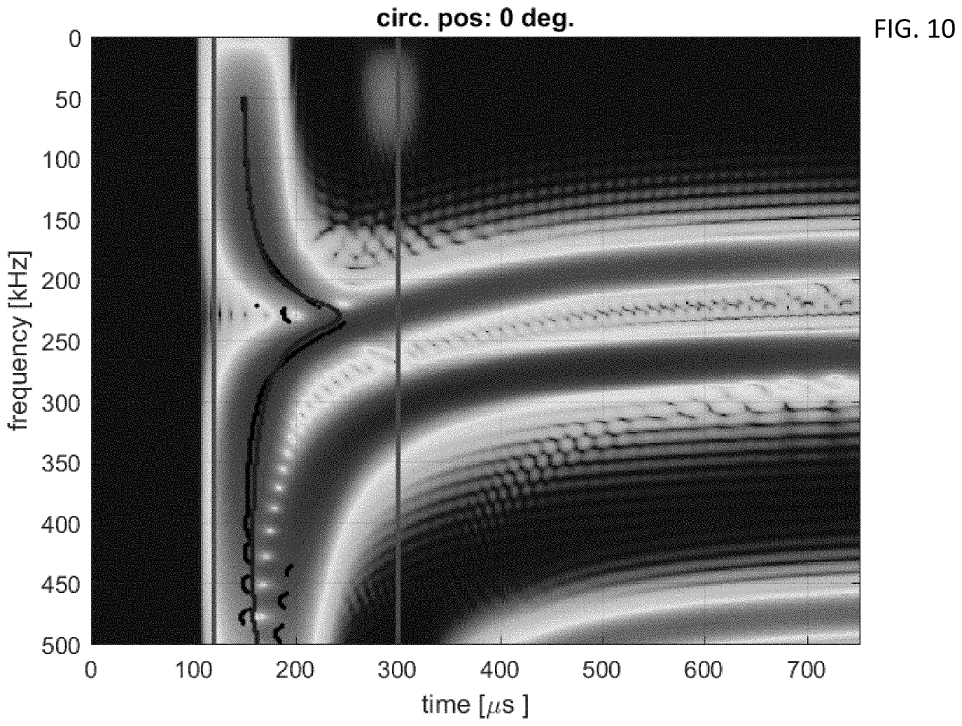

In the spectrogram of FIG. 7, the time picks (measurements) are shown in black and the expected dispersion curves in dark green for a modeled scale thickness of 6 mm on a 7 mm thick steel tubing wall. The time picks and the minimum of the expected dispersion curves are also illustrated by themselves in FIG. 8A. The dispersion curves are computed in a range of 0 to 25 mm scale thickness for a specific circumferential position (90° in this case). An objective function is chosen (in this case, a least squares fit, as illustrated in FIG. 8B), to map the observed times (time measurements) to the closest modeled average scale thickness consistent with the data. In this case, an average scale thickness of 5.8 mm is found, as highlighted in FIG. 8B (smallest objective function value). The procedure is repeated for all receivers around the circumference of the pipe, as represented in FIG. 9. This procedure can be extended to a two parameter problem, such as scale and wall thickness, as illustrated in FIGS. 10-13.

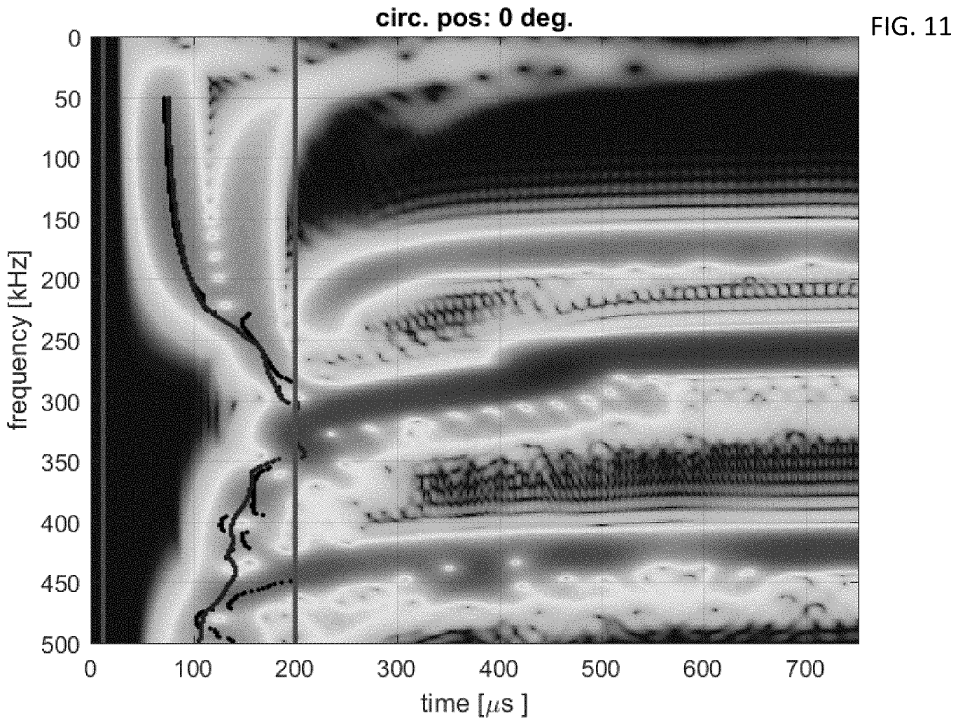

FIG. 10 is a color plot illustrating example scale thickness and pipe wall thickness (corrosion) determinations based on first arrival time measurements using torsional UGWs and a (two-dimensional) time-frequency analysis, with overlaying minimum computed group velocity dispersion curve, such as for use with a scale and corrosion monitoring system, according to an embodiment. FIG. 11 is a corresponding color plot of two-dimensional time-frequency analysis and overlaying minimum computed group velocity dispersion curve to the plot of FIG. 10, only this time for longitudinal UGWs. In FIGS. 10-11, the x-axis represents propagation time (in μs) while the y-axis represents UGW frequency (in kHz).

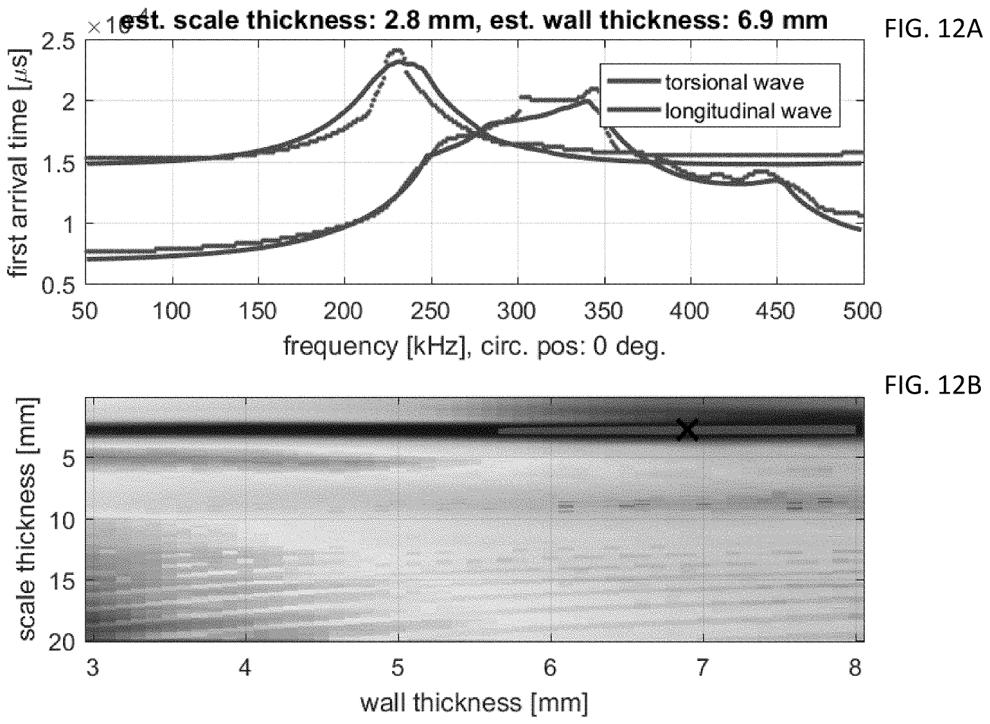

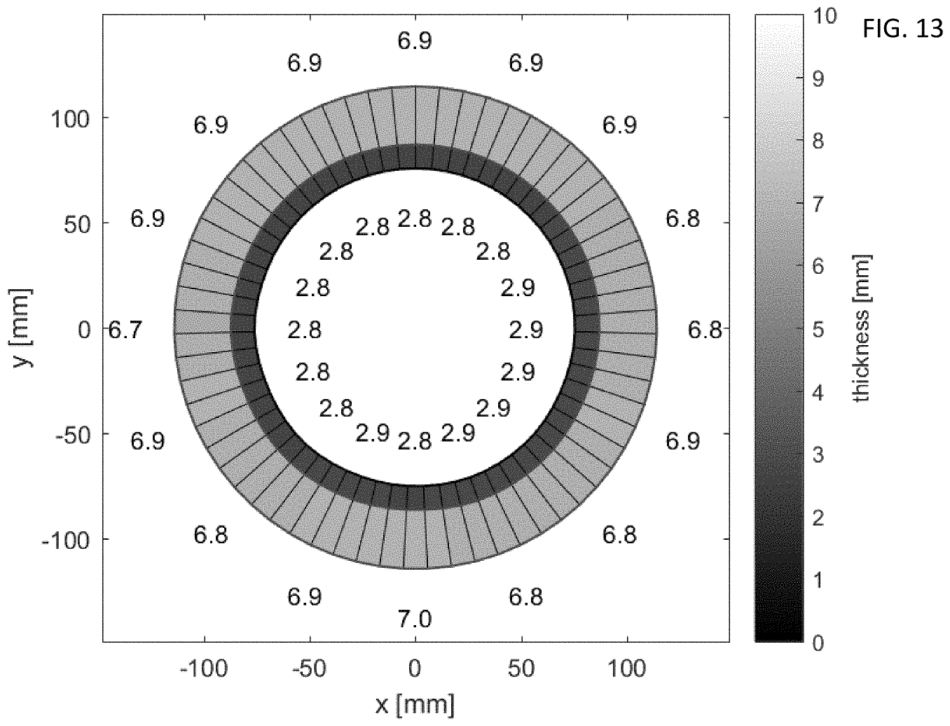

FIG. 12A is a corresponding graph of the first arrival time measurements and minimum computed group velocity dispersion curves of FIGS. 10 and 11. In FIG. 12A, the x-axis represents UGW frequency (in kHz) while the y-axis represents first arrival time (in hundreds of μs). FIG. 12B is a color plot of an example two-variable (two dimensional or 2D, including wall thickness and scale thickness) objective function that measures how well the first arrival time measurements of FIGS. 10 and 11 fit the respective minimum computed group velocity dispersion curves, together with an identification of the determined minimum objective function (best fit), such as for use with a scale and corrosion monitoring system, according to an embodiment. In FIG. 12B, the x-axis represents wall thickness (in mm) while the y-axis represents scale thickness (in mm). FIG. 13 is a corresponding schematic graph of the scale thicknesses (inside numbers) and wall thicknesses (corrosion indicator, outside numbers) at 16 different angular positions around the pipe circumference, as determined using the technique illustrated in FIGS. 10-12B on respective sets of first arrival time measurements from respective circumferentially positioned transducers.

As a result of simulations such as the ones used to produce FIGS. 10-13, torsional UGWs appear to be more sensitive to scale thicknesses whereas longitudinal UGWs provide a better sensitivity to pipe wall thickness variations. This can be visualized in the objective function plot of FIG. 12B by two contours in the 2D objective function. Here, the green contour (torsional UGWs) is narrow in the scale thickness direction but long in the pipe wall thickness direction. By contrast, he red contour (longitudinal UGWs) is narrower in the tubing wall direction, which results in better resolution for measuring pipe wall loss such as corrosion damage.

Moreover, the wave mode shapes for longitudinal UGWs that arrive first for a specific frequency component is predominantly in-plane, which supports a conclusion that these wave modes do not couple into the liquid in the annulus (TCA) between the tubing and the casing. This is an important property to make the measurements and scale/corrosion determinations insensitive to the well completion (casing/cement/formation). Put another way, the contour lines in the FIG. 12B illustration of the objective function are narrower for the longitudinal UGWs (red) than for the torsional UGWs (green). This indicates that longitudinal UGWs are more sensitive in measuring wall thickness than torsional UGWs.

The described techniques herein can be implemented using a combination of sensors, transmitters, and other devices including computing or other logic circuits configured (e.g., programmed) to carry out their assigned tasks. These devices are located on or in (or otherwise in close proximity to) the pipe, ultrasonic transducers, or processing circuitry for carrying out the techniques. In some example embodiments, the control logic is implemented as computer code configured to be executed on a computing circuit (such as a microprocessor) to perform the control steps that are part of the technique. For ease of description, this processing logic (e.g., ASIC, FPGA, processor, custom circuit, or the like) will be referred to as a processing circuit throughout. For further ease of description, this processing circuit is programmable by code to perform the processing logic (or otherwise customize the processing circuit to perform its intended purpose).

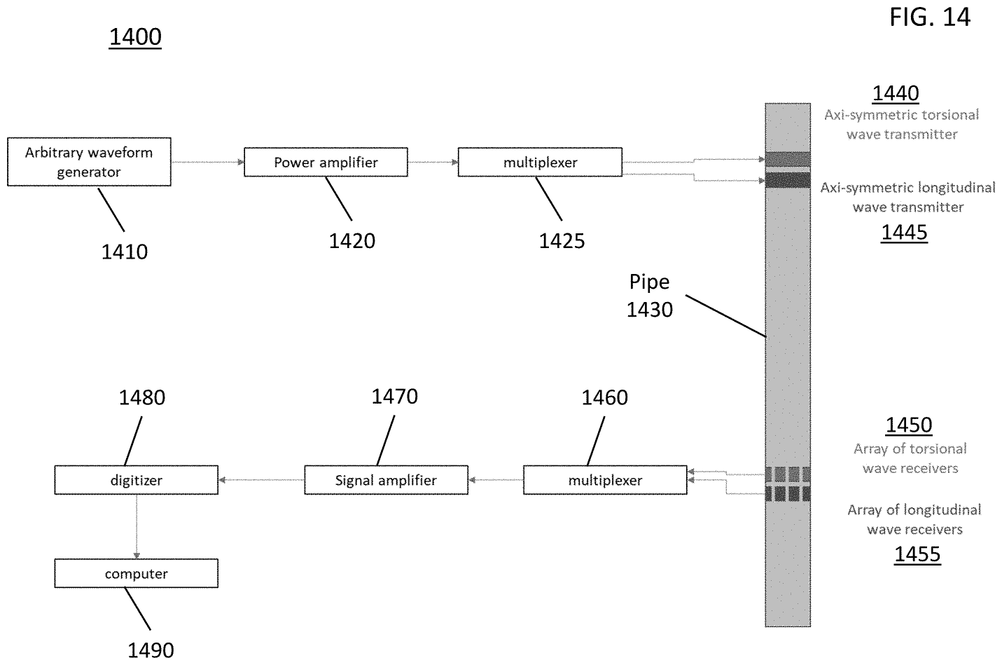

FIG. 14 is a schematic diagram of an example scale and corrosion monitoring system 1400 using UGWs, such as for measuring scale buildup or corrosion damage for a pipe 1430, according to an embodiment. The system includes an arbitrary waveform generator 1410, a power amplifier 1420, a first multiplexer 1425, an axisymmetric torsional UGW transmitter 1440 about the pipe 1430, an axisymmetric longitudinal UGW transmitter 1445 about the pipe 1430, an array of torsional UGW receivers 1450 equally spaced around the pipe 1430, an array of longitudinal UGW receivers 1455 equally spaced around the pipe 1430, a second multiplexer 1460, a signal amplifier 1470, a digitizer 1480, and a processing circuit (computer) 1490.

In further detail, the arbitrary waveform generator 1410 emits a wide band frequency sweep, such as from 50 kHz to 750 kHz, with an example length of 2 milliseconds (ms). The sweep is amplified by the power amplifier 1420 to an amplitude of about 100 V peak to drive transducers 1440 and 1445 generating axisymmetric waves. Both the torsional wave transducer 1440 and the longitudinal wave transducer 1445 are used. Both cover a frequency range of 100 kHz to 500 kHz for a nominal pipe wall thickness of 7 mm. The first multiplexer 1425 is used to switch between the two transducers 1440 and 1445. It should be noted that the frequency range of 100 kHz to 500 kHz is but an example. In some embodiments, for different nominal wall thicknesses, the product of frequency and wall thickness is kept constant in order to calculate the appropriate working frequency range.

At a certain distance from the transmitters 1440 and 1445 (spanning the portion of the pipe 1430 whose scale and corrosion are to be monitored), the two receiver arrays 1450 and 1455 are mounted. One receiver array 1450 receives and records the torsional UGWs while the other receiver array 1455 receives and records the longitudinal UGWs. In some embodiments, each receiver array 1450 and 1455 includes 8 to 16 receivers. The received signals are individually recorded, which can be achieved by multiplexing through the second multiplexer 1460. The received signals are amplified by the signal amplifier 1470 and digitized by the digitizer 1480. The digitized recorded signals are stored in the computer 1490 (such as on a non-transitory storage device) for further data processing and analysis.

The transmitters 1440 and 1445 and the receivers 1450 and 1455 are positioned such that the distance between the torsional wave transmitter 1440 and the torsional wave receivers 1450 is equal to the distance between longitudinal wave transmitter 1445 and the longitudinal wave receivers 1455, which helps simplify some of the data processing and comparing between the two sets of transmitters and receivers. In some embodiments, EMAT transducers (Lorentz force or magnetostriction based) are used to generate the required UGWs. The electric coil design in the EMAT transducers is convenient for generating axisymmetric waves. Magnetostriction requires a special foil to be bonded/welded to the pipe. The magnetostriction principle allows for generation of much stronger signals compared to Lorentz-force based transduction. In some embodiments, piezo electric transducers providing a shear motion are used to detect the propagated UGWs. Piezo based systems have good sensitivity and small dimensions.

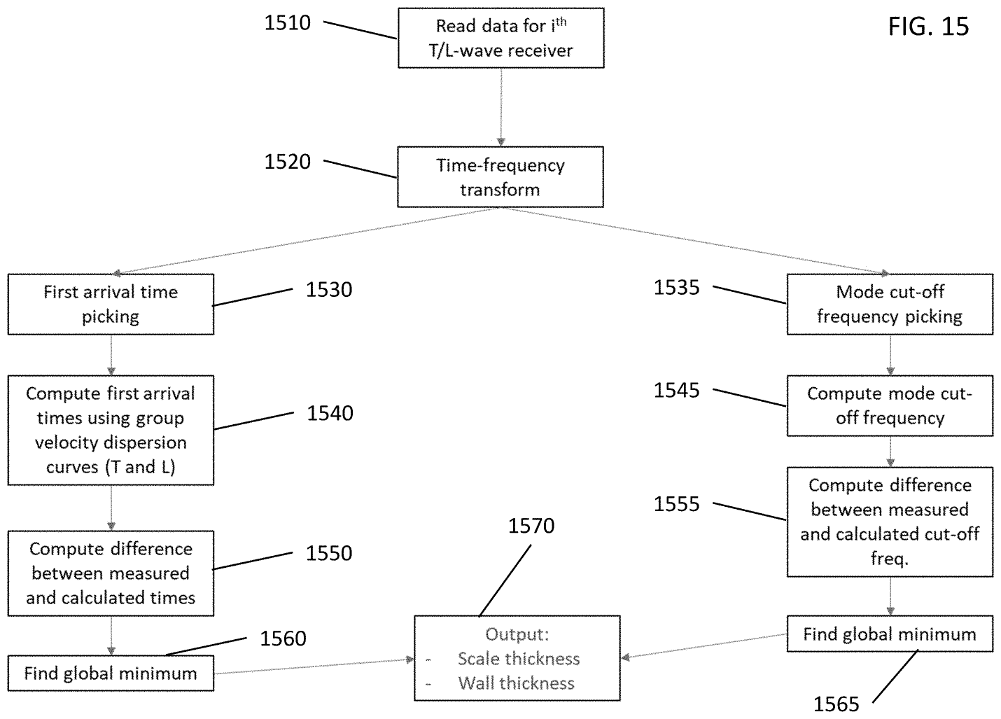

FIG. 15 is a flow diagram of an example method 1500 of scale and corrosion monitoring using UGWs, such as for a pipe (e.g., pipe 1430) according to an embodiment.

Some or all of the method 1500 can be performed using components and techniques illustrated in FIGS. 1 through 14. Portions of this and other methods disclosed herein can be performed on or using a custom or preprogrammed logic device, circuit, or processor, such as a programmable logic circuit (PLC), computer, software, or other circuit (e.g., ASIC, FPGA) configured by code or logic to carry out their assigned task. The device, circuit, or processor can be, for example, a dedicated or shared hardware device (such as a laptop, a single board computer (SBC), a workstation, a tablet, a smartphone, part of a server, or a dedicated hardware circuit, as in an FPGA or ASIC, or the like), or computer server, or a portion of a server or computer system. The device, circuit, or processor can include a non-transitory computer readable medium (CRM, such as read-only memory (ROM), flash drive, or disk drive) storing instructions that, when executed on one or more processors, cause portions of the method 1500 (or other disclosed method) to be carried out. It should be noted that in other embodiments, the order of the operations can be varied, and that some of the operations can be omitted. Some or all of the method 1500 can also be performed using logic, circuits, or processors located on or in electrical communication with a processing circuit configured to carry out the method 1500.

In the method 1500, processing begins with the step of reading 1510 the recorded signals for both the torsional wave and longitudinal wave receivers at one specific circumferential position in the array. Both wave modes are used to improve accuracy of the scale thickness and wall thickness determinations. The method 1500 further includes the step of performing 1520 a time-frequency analysis of the read signals. At this point, two distinct features in this domain can be used: (1530) the first arrival time as a function of frequency or (1535) the mode cutoff frequency (e.g., horizontal lines in this domain). In some embodiments, both first arrival time and mode cutoff frequency are used (e.g., together to improve accuracy, or one or the other depending on which is more appropriate). In addition, the desired output 1570 from the method 1500 should be selected, such as scale thickness, pipe wall thickness, or both.

The approach using first arrival times (1530) is as follows. The first arrival times are compared to calculated first arrival times. For this purpose, a set of group velocity dispersion curves (such as group velocity expressed as a function of frequency) is calculated (e.g., modeled) in advance for a range of scale thicknesses and wall thicknesses. For each frequency, the highest group velocity is determined. Using the known distance between transmitter and receiver, the method 1500 further includes the step of computing 1540 the first arrival time for each frequency component using the group velocity dispersion curves (torsional and longitudinal). For each combination of scale and wall thicknesses, the method 1500 further includes the step of computing 1550 the difference between the measured and calculated first arrival times. The method 1500 further includes the step of finding 1560 a global minimum of an objective function in order to identify the modeled scale thickness and wall thickness that best fits the measured first arrival times. The method 1500 further includes the step of outputting 1570 the identified scale thickness and wall thickness.

In an example embodiment, the objective function includes summing the absolute differences between the measured first arrival times and the modeled first arrival times over all frequency components. This is generally referred to as an L1-norm. An example of such an objective function is shown in FIG. 12B. This domain contains several local minima and one clear overall minimum, which is the correct value. Because of all the local minima, other approaches for the objective function, such as a least-squares optimization approach to find the global minimum, do not work well. Moreover, least squares is more computationally demanding than an L1 norm. The proposed L1 norm approach is fast and robust. The L1-norm helps minimize the influence of picking errors and a few outliers. This process is repeated for all receivers in the circumferential array. An example output of this process is shown in FIG. 13. The inner numbers are the scale thicknesses and the outer numbers are the pipe wall thicknesses. The values are the axially averaged thicknesses of the pipe in between the transmitter and the receivers.

The approach using the mode cutoff frequencies (1535) is similar. Here, an analytical expression (such as the analytical expression in FIG. 2) provides a fast way to perform the step of computing 1545 the mode cutoff frequencies. As such, it is not necessary to pre-compute (e.g., model) a set of group-velocity dispersion curves. As with the first arrival time approach, an objective function is constructed by performing the step of computing 1555 the differences between the measured and calculated cutoff frequencies. In addition, the method 1500 includes the step of finding 1565 the global minimum of the objective function to determine the scale and pipe wall thicknesses. The method 1500 further includes the step of outputting 1570 these determined scale and wall thicknesses, possibly in addition to or to account for (e.g., average, choose the most appropriate, or the like) similar thicknesses determined by the first arrival time path.

It should be noted that the mode cut-off frequencies become hard to detect in case of rough scaled surface due to wave scattering. In this situation, the first arrival time approach is more robust because the first arriving UGWs are minimally affected by scattering.

The methods described herein may be performed in part or in full by software or firmware in machine readable form on a tangible (e.g., non-transitory) storage medium. For example, the software or firmware may be in the form of a computer program including computer program code adapted to perform some or all of the steps of any of the methods described herein when the program is run on a computer or suitable hardware device (e.g., FPGA), and where the computer program may be embodied on a computer readable medium. Examples of tangible storage media include computer storage devices having computer-readable media such as disks, thumb drives, flash memory, and the like, and do not include propagated signals. Propagated signals may be present in a tangible storage media, but propagated signals by themselves are not examples of tangible storage media. The software can be suitable for execution on a parallel processor or a serial processor such that the method steps may be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A nondestructive method of monitoring scale buildup in a section of pipe, the method comprising:
transmitting, from a first transducer at a first location of the pipe, axisymmetric torsional ultrasonic guided waves (UGWs) to propagate along the pipe, the torsional UGWs spanning a frequency band comprising multiple higher order modes;
receiving, by a second transducer at a second location of the pipe separated from the first location, the propagated torsional UGWs; and
determining, by a processing circuit, a thickness of the scale buildup in the pipe between the first location and the second location using the received torsional UGWs, comprising:
measuring attributes from the received torsional UGWs, the attributes being first arrival times or mode cutoff frequencies;
comparing the measured attributes to sets of computed said attributes, each set representing a different scale buildup thickness;
selecting the compared set of computed attributes that is closest to the measured attributes; and
outputting the scale buildup thickness corresponding to the selected set for the section of pipe between the first and second locations.

2. The method of claim 1, wherein the second transducer comprises a ring of second transducers about a circumference of the pipe at the second location, each second transducer corresponding to a different circumferential position about the pipe, and determining the thickness of the scale buildup comprises determining the thickness of the scale buildup for each circumferential position about the pipe using the received torsional UGWs of the corresponding second transducer.

3. The method of claim 1, further comprising:
transmitting, from a third transducer at a third location of the pipe, axisymmetric longitudinal UGWs to propagate along the pipe, the longitudinal UGWs spanning a frequency band comprising multiple higher order modes;
receiving, by a fourth transducer at a fourth location of the pipe separated from the third location, the propagated longitudinal UGWs; and
determining, by the processing circuit, the thickness of the scale buildup in the pipe between the third location and the fourth location using the received longitudinal UGWs, comprising:
measuring the attributes from the received longitudinal UGWs;
comparing the measured longitudinal attributes to second sets of computed said attributes, each second set representing a different scale buildup thickness;
selecting the compared second set of computed attributes that is closest to the measured longitudinal attributes; and
outputting the scale buildup thickness corresponding to the selected second set for a second section of pipe between the third and fourth locations.

4. The method of claim 3, wherein the distance between the first and third locations of the pipe is the same as the distance between the second and fourth locations of the pipe.

5. The nondestructive method of claim 1, further comprising:
transmitting, from a third transducer at a third location of the pipe, axisymmetric longitudinal UGWs to propagate along the pipe, the longitudinal UGWs spanning a frequency band comprising multiple higher order modes;
receiving, by a fourth transducer at a fourth location of the pipe separated from the third location, the propagated longitudinal UGWs; and
determining, by the processing circuit, the thickness of the wall of the pipe between the third location and the fourth location using the received longitudinal UGWs, comprising:
measuring the attributes from the received longitudinal UGWs;
comparing the measured longitudinal attributes to second sets of computed said attributes, each second set representing a different pipe wall thickness;
selecting the compared second set of computed attributes that is closest to the measured longitudinal attributes; and
outputting the pipe wall thickness corresponding to the selected second set for a second section of pipe between the third and fourth locations.

6. The method of claim 5, wherein:
the second transducer comprises a ring of second transducers about a circumference of the pipe at the second location, each second transducer corresponding to a different circumferential position about the pipe, and determining the thickness of the scale buildup comprises determining the thickness of the scale buildup for each circumferential position about the pipe using the received torsional UGWs of the corresponding second transducer; and
the fourth transducer comprises a ring of fourth transducers about a circumference of the pipe at the fourth location, each fourth transducer corresponding to a different circumferential position about the pipe, and determining the thickness of the pipe wall comprises determining the thickness of the pipe wall for each circumferential position about the pipe using the received longitudinal UGWs of the corresponding fourth transducer.

7. The method of claim 6, wherein the second location of the pipe coincides with the fourth location, and the second transducers interleave with the fourth transducers about the circumference of the pipe.

8. A nondestructive method of monitoring scale buildup and corrosion in a section of pipe, the method comprising:
transmitting, from a first transducer at a first location of the pipe, axisymmetric torsional ultrasonic guided waves (UGWs) to propagate along the pipe, the torsional UGWs spanning a frequency band comprising multiple higher order modes;
receiving, by a second transducer at a second location of the pipe separated from the first location, the propagated torsional UGWs;
transmitting, from a third transducer at a third location of the pipe, axisymmetric longitudinal UGWs to propagate along the pipe, the longitudinal UGWs spanning a frequency band comprising multiple higher order modes;
receiving, by a fourth transducer at a fourth location of the pipe separated from the third location, the propagated longitudinal UGWs; and
determining, by a processing circuit, a thickness of the scale buildup in the pipe and a thickness of the wall of the pipe using the received torsional UGWs and the received longitudinal UGWs, comprising:
measuring attributes from the received torsional UGWs and the received longitudinal UGWs, the attributes being first arrival times or mode cutoff frequencies;
comparing the measured attributes to sets of computed said attributes, each set representing a different combination of scale buildup thickness and pipe wall thickness;
selecting the compared set of computed attributes that is closest to the measured attributes; and
outputting the scale buildup thickness and the pipe wall thickness corresponding to the selected set for the section of pipe between the first and second locations.

9. The method of claim 8, wherein:
the second transducer comprises a ring of second transducers about a circumference of the pipe at the second location, each second transducer corresponding to a different circumferential position about the pipe;
the fourth transducer comprises a ring of fourth transducers about a circumference of the pipe at the fourth location, each fourth transducer corresponding to a different circumferential position about the pipe; and
determining the thickness of the scale buildup and the thickness of the pipe wall comprises determining the thickness of the scale buildup and the thickness of the pipe wall for each circumferential position about the pipe using the received torsional UGWs of the corresponding second transducer and the received longitudinal UGWs of the corresponding fourth transducer.

10. The method of claim 9, wherein the second location of the pipe coincides with the fourth location, and the second transducers interleave with the fourth transducers about the circumference of the pipe.

11. A system for nondestructively monitoring scale buildup in a section of pipe, the system comprising:
a first transducer configured to transmit axisymmetric torsional ultrasonic guided waves (UGWs) from a first location of the pipe, to propagate along the pipe, the torsional UGWs spanning a frequency band comprising multiple higher order modes;
a second transducer configured to receive the propagated torsional UGWs at a second location of the pipe separated from the first location; and
a processing circuit configured to determine a thickness of the scale buildup in the pipe between the first location and the second location using the received torsional UGWs by:
measuring attributes from the received torsional UGWs, the attributes being first arrival times or mode cutoff frequencies;
comparing the measured attributes to sets of computed said attributes, each set representing a different scale buildup thickness;
selecting the compared set of computed attributes that is closest to the measured attributes; and
outputting the scale buildup thickness corresponding to the selected set for the section of pipe between the first and second locations.

12. The system of claim 11, wherein the second transducer comprises a ring of second transducers about a circumference of the pipe at the second location, each second transducer corresponding to a different circumferential position about the pipe, and the processing circuit determines the thickness of the scale buildup by determining the thickness of the scale buildup for each circumferential position about the pipe using the received torsional UGWs of the corresponding second transducer.

13. The system of claim 11, further comprising:
a third transducer configured to transmit axisymmetric longitudinal UGWs from a third location of the pipe, to propagate along the pipe, the longitudinal UGWs spanning a frequency band comprising multiple higher order modes; and
a fourth transducer configured to receive the propagated longitudinal UGWs at a fourth location of the pipe separated from the third location,
wherein the processing circuit is further configured to determine the thickness of the scale buildup in the pipe between the third location and the fourth location using the received longitudinal UGWs by:
measuring the attributes from the received longitudinal UGWs;
comparing the measured longitudinal attributes to second sets of computed said attributes, each second set representing a different scale buildup thickness;
selecting the compared second set of computed attributes that is closest to the measured longitudinal attributes; and
outputting the scale buildup thickness corresponding to the selected second set for a second section of pipe between the third and fourth locations.

14. The system of claim 13, wherein the distance between the first and third locations of the pipe is the same as the distance between the second and fourth locations of the pipe.

15. The nondestructive system of claim 11, further comprising:
a third transducer configured to transmit axisymmetric longitudinal UGWs, from a third location of the pipe, to propagate along the pipe, the longitudinal UGWs spanning a frequency band comprising multiple higher order modes; and
a fourth transducer configured receive the propagated longitudinal UGWs at a fourth location of the pipe separated from the third location,
wherein the processing circuit is further configured to determine the thickness of the wall of the pipe between the third location and the fourth location using the received longitudinal UGWs by:
measuring the attributes from the received longitudinal UGWs;
comparing the measured longitudinal attributes to second sets of computed said attributes, each second set representing a different pipe wall thickness;
selecting the compared second set of computed attributes that is closest to the measured longitudinal attributes; and
outputting the pipe wall thickness corresponding to the selected second set for the second section of pipe between the third and fourth locations.

16. The system of claim 15, wherein:
the second transducer comprises a ring of second transducers about a circumference of the pipe at the second location, each second transducer corresponding to a different circumferential position about the pipe, and the processing circuit determines the thickness of the scale buildup by determining the thickness of the scale buildup for each circumferential position about the pipe using the received torsional UGWs of the corresponding second transducer; and
the fourth transducer comprises a ring of fourth transducers about a circumference of the pipe at the fourth location, each fourth transducer corresponding to a different circumferential position about the pipe, and the processing circuit determines the thickness of the pipe wall by determining the thickness of the pipe wall for each circumferential position about the pipe using the received longitudinal UGWs of the corresponding fourth transducer.

17. The system of claim 16, wherein the second location of the pipe coincides with the fourth location, and the second transducers interleave with the fourth transducers about the circumference of the pipe.

18. A system for nondestructively monitoring scale buildup and corrosion in a section of pipe, the system comprising:
a first transducer configured to transmit axisymmetric torsional ultrasonic guided waves (UGWs) from a first location of the pipe, to propagate along the pipe, the torsional UGWs spanning a frequency band comprising multiple higher order modes;
a second transducer configured to receive the propagated torsional UGWs at a second location of the pipe separated from the first location;
a third transducer configured to transmit axisymmetric longitudinal UGWs from a third location of the pipe, to propagate along the pipe, the longitudinal UGWs spanning a frequency band comprising multiple higher order modes;
a fourth transducer configured to receive the propagated longitudinal UGWs at a fourth location of the pipe separated from the third location; and
a processing circuit configured to determine a thickness of the scale buildup in the pipe and a thickness of the wall of the pipe using the received torsional UGWs and the received longitudinal UGWs by:
measuring attributes from the received torsional UGWs and the received longitudinal UGWs, the attributes being first arrival times or mode cutoff frequencies;
comparing the measured attributes to sets of computed said attributes, each set representing a different combination of scale buildup thickness and pipe wall thickness;
selecting the compared set of computed attributes that is closest to the measured attributes; and
outputting the scale buildup thickness and the pipe wall thickness corresponding to the selected set for the section of pipe between the first and second locations.

19. The system of claim 18, wherein:
the second transducer comprises a ring of second transducers about a circumference of the pipe at the second location, each second transducer corresponding to a different circumferential position about the pipe;
the fourth transducer comprises a ring of fourth transducers about a circumference of the pipe at the fourth location, each fourth transducer corresponding to a different circumferential position about the pipe; and
the processing circuit determines the thickness of the scale buildup and the thickness of the pipe wall by determining the thickness of the scale buildup and the thickness of the pipe wall for each circumferential position about the pipe using the received torsional UGWs of the corresponding second transducer and the received longitudinal UGWs of the corresponding fourth transducer.

20. The system of claim 19, wherein the second location of the pipe coincides with the fourth location, and the second transducers interleave with the fourth transducers about the circumference of the pipe.
